(19) United States
(12) Patent Application Publication
(10) Pub. No.: US 2007/0227582 A1
(43) Pub. Date: Oct. 4, 2007

(54) Low aspect ratio concentrator photovoltaic module with improved light transmission and reflective properties

(76) Inventors: Peter Zupei Chen, Cupertino, CA (US); Christina Ye Chen, Cupertino, CA (US)

Correspondence Address: WOODSIDE IP GROUP, P.O. BOX 61047, PALO ALTO, CA, 94306, US

(21) Appl. No.: 11/527,045

(22) Filed: Sep. 26, 2006

Related U.S. Application Data
(63) Continuation-in-part of application No. 11/390,045, filed on Mar. 28, 2006.

(51) Int. Cl. H02N 6/00

(52) U.S. Cl. 136/246

(57) ABSTRACT

A low aspect ratio concentrator photovoltaic module has blazed grating surfaces on the light incident and/or reflective light planes that direct optimal wavelengths of light energy to a photo receptor enabling a total internal reflection condition to be achieved with a significantly smaller apex angle. Apex angles can be achieved that are 10° or less depending on the blazed grating angle and groove density, thereby providing a low aspect ratio prism that achieves a dramatic savings in silicon; using only 15 to 20 per cent of the silicon used in a conventional solar module without loss of photovoltaic efficiency. This achieves a significant reduction in the overall material and weight of the prism, making possible a low cost, lightweight, and highly efficient PV module suitable for widespread implementation.

### CROSS-REFERENCE TO RELATED APPLICATION

This patent application is a continuation in part of U.S. patent application Ser. No. 11/390,045 filed Mar. 28, 2006, which is incorporated herein by reference.

### BACKGROUND

1. Field of the Invention

The field of the present invention relates to photovoltaic (PV) modules. More particularly, the field of the invention is related to a concentrator PV module comprising a an array of solar cells integrated with a low concentrator prism characterized by total internal reflection (TIR) and having an apex angle and surface characteristics providing enhanced collection and conversion of optical radiation, wherein each solar cell uses only half or less of the amount of silicon of a conventional solar cell, while providing substantially equal or greater photovoltaic conversion efficiency.

2. Background of Related Art

A PV cell converts photon energy to electrical energy in a safe, convenient, pollution-free manner. A PV cell provides photogeneration of charge carriers (electrons and holes) in a light-absorbing material. There are many types of PV cells including crystalline silicon PV cells, thin film PV cells, organic PV cells, optical-thermal PV cells, or the like. Separation of the charge carriers to conductive contacts or electrodes on the surface of the PV cell transmits the electrical energy. Since the energy output from a single PV cell is very limited, typically a plurality of PV cells is connected together via interconnections to form a PV cell array that comprises a typical PV module. A PV module can produce from tens to thousand watts of electrical power at the standard voltage.

The most common PV modules comprise polycrystalline, amorphous or single crystal silicon solar cells. FIG. 1 illustrates a conventional crystalline silicon PV module 100, which is formed by a plurality of PV cell elements 115 connected by interconnections 116, 117, and 118. These PV cell elements and interconnections are encapsulated within the encapsulation layer 112, wherein the encapsulation layer 112 is sandwiched in between the cover glass 111 and substrate 113. Current output of a typical crystalline silicon PV cell is provided at first and second electrodes 114 and 119, respectively. The crystalline silicon PV module 100 is characterized by a planar shape and large view angle. The light receiving surface of such a conventional planar solar module is coextensive with the silicon substrate. This results in am undesirably large amount of silicon wafer surface area that is necessary for photovoltaic conversion.

Silicon is currently the main cost factor in PV modules. 95% of the today's PV modules use silicon based photoreceptors. In view of a current worldwide shortage in silicon wafers and silicon wafer processing capacity, it would be desirable to provide a PV module requiring far less silicon in its construction. Therefore, what is needed is a low cost PV module capable of providing a significant reduction in silicon usage when compared with conventional flat plate and low concentrator solar modules, including prism based solar modules, while achieving equal or superior photovoltaic conversion efficiency.

A conventional concentrator PV module is developed and constructed by integrating a plurality of PV cell arrays and optical components such as curved mirrors or Fresnel lenses. Optical components are used as concentrators to focus light to the PV cell array. Thus, the silicon wafer surface does not need to be coextensive with the light gathering surface. This can greatly decrease the overall manufacturing cost of such a PV module. However, the view angle of such a conventional optical component is relatively narrow. Therefore; a sunlight tracker is added a concentrator PV system to maximize exposure to available sunlight and generate electrical energy in a cost effective way. However, the complexity of moving parts of a tracker system, and the need for energy to power the tracking system add additional cost and significant maintenance expenses over the lifetime of the PV system.

Concentrator PV systems are also limited to capturing radiation energy from direct sunlight. Due to the limited view angle, diffuse radiation cannot be captured efficiently. This factor tends to limit the economic use of concentrator PV systems to geographic regions with a high portion of direct sunlight, such as the United States South West, the Mediterranean region, Australia, or similar arid regions that may be undesirably distant from major population centers where energy is needed.

A conventional concentrator PV module using a reflection prism as a concentrator with total internal reflection (TIR) characteristics is disclosed in FIG. 2 and FIG. 3. The TIR capability is determined by the apex angle of the prism. For typical glass prisms the apex angle has to be larger than approximately 25 degrees, which results in a magnification of the incoming radiation by approximately a factor of two. The exact physical relationship is determined by:

Magnification=1/sin(apex angle β)

U.S. Pat. No. 6,294,723 discloses a concentrator PV module 300 comprising a plurality of reflection prisms comprising a monolithic prism array 300, see FIG. 3. Each prism 301 has a triangular shape with a reflection mirror 302 on one surface resulting in total internal reflection on the incident light surface 304 such that light is reflected toward a photo detector 307. The overall optical characteristics are practically the same as those of an individual prism based concentrator as shown in FIG. 2 The main disadvantages of this approach are as follows. There is limited magnification; therefore a greater amount of silicon is needed for efficient photovoltaic conversion. Thus, savings in expensive silicon are limited. The view angle also is undesirably decreased with resulting limited diffused light energy conversion.

Referring again to FIGS. 2 and 3, conventional prism based PV concentrators typically employ an additional flat face glass on the incident light plane of the prism. This arrangement leads to a photo conversion loss due to reflection from the incident light plane on the order of 4% (for glass with a typical refractive index of 1.5). Another optical disadvantage of such a prism concentrator is that a significant portion of diffuse light cannot be captured by a conventional prism. For example, in a typical case a using conventional glass prism, 80 degrees of the total 180 degrees of the incoming radiation are lost, when a prism with apex angle of 25 degrees is being used.

### SUMMARY

In order to overcome the foregoing limitations and disadvantages inherent in a conventional solar module, an aspect of the invention provides a prism solar module with TIR having a low aspect ratio and improved surface characteristics on the light incident and reflective planes for capturing and directing an increased amount of solar radiation, particularly an increased amount of diffused light, to an integrated solar array.

Another aspect of the invention provides a major increase in view angle (close to 180 degrees) that leads to a dramatic increase in the ability to capture and utilize diffuse light as compared to conventional prism solar modules.

A further aspect of the present invention comprises the employment of a blazed grating on a light incident and/or on a reflective surface of a prism that increases the reflection of diffused optical radiation to a photon absorbing surface while enabling a significant decrease in the apex angle of the prism. A blazed grating on the reflective plane decreases the apex angle needed for total internal reflection and makes possible a low aspect ratio prism that achieves a dramatic savings in silicon; using only 15 to 20 per cent of the silicon used in a conventional solar module without loss of photovoltaic efficiency. This achieves a significant reduction in the overall material and weight of the prism, thereby making possible a low cost, lightweight, and highly efficient PV module suitable for widespread implementation.

A further aspect of the present invention incorporates the flexibility to work with any type of currently available photo detector, including mono-crystalline silicon, polycrystalline silicon, Gallium Arsenide based detectors, thin film detectors, organic based detectors, or the like. In the following text it is to be understood that the term “silicon” is synonymous with the foregoing photo detector materials.

### BRIEF DESCRIPTION OF THE DRAWINGS

The drawings are heuristic for clarity. The foregoing and other features, aspects and advantages of the invention will become better understood with regard to the following description, appended claims and accompanying drawings in which:

FIG. 1 is a side view of a conventional planar solar cell.

FIG. 2 is a side view of a conventional prism collector solar cell.

FIG. 3 is a side view of a conventional collector solar cell comprising a plurality of prisms.

FIG. 4A is a conceptual drawing for defining a module element comprising a prism and integrated solar cell for collection and utilization of solar energy.

FIG. 4B shows orientation of the module element of FIG. 4A with respect to changing orientation of the sun to minimize shadowing effect.

FIG. 5A is a perspective side view of a prism and integrated solar array wherein the light incident surface comprises a grating in accordance with an aspect of the invention.

FIG. 5B is a side view of a light incident surface in accordance with an aspect of the invention.

FIG. 5C is an enlarged view of the light incident surface of FIG. 5B.

FIG. 6A is a perspective side view of a low aspect ratio prism and integrated solar array showing the collection and reflection of incident light in accordance with an aspect of the invention.

FIG. 6B is a side view of the low aspect ratio prism and integrated solar array of FIG. 6A in accordance with an aspect of the invention.

FIG. 7A is a perspective side view of another embodiment of a low aspect ratio prism and concentrator PV module showing the collection and reflection of incident light in accordance with an aspect of the invention.

FIG. 7B is a side view of the concentrator PV module shown in FIG. 7A.

FIG. 7C is an enlarged side view of the concentrator PV module of FIG. 7B showing details of the blazed grating.

FIG. 8A is a perspective side view of another embodiment of a low aspect ratio prism and integrated solar array showing the collection and reflection of incident light in accordance with an aspect of the invention.

FIG. 8B is a side view of the low aspect ratio prism and integrated solar array shown in FIG. 8A.

FIG. 9A is a perspective side view of another embodiment of a low aspect ratio prism and integrated solar array showing the collection and reflection of incident light in accordance with an aspect of the invention.

FIG. 9B is a side view of the low aspect ratio prism and integrated solar array shown in FIG. 9A.

FIG. 10 is a perspective side view of an alternate embodiment comprising multiple prisms and solar arrays integrated into a solar module having a single light incident grating surface in accordance with an aspect of the invention.

FIG. 11A is a perspective side view of an alternate embodiment comprising multiple prisms and solar arrays with transmission and reflective gratings integrated into a single solar module in accordance with an aspect of the invention.

FIG. 11B is a side view of the embodiment of FIG. 11A.

FIG. 12 is a side view showing the integration of a solar module into a product including a cover glass and frame in accordance with an aspect of the invention.

FIG. 13 is a side view of a solar module using a single piece of glass having V groove and reflective grating surfaces in accordance with an aspect of the invention.

FIG. 14 is a side view showing a solar module comprising a blazed grating on the incident and reflective surfaces, wherein the blazed grating is constructed from a single piece of glass in accordance with an aspect of the invention.

FIG. 15 is a side view showing another embodiment of the solar module of FIG. 14 wherein the solar module has gratings constructed from a single piece of glass.

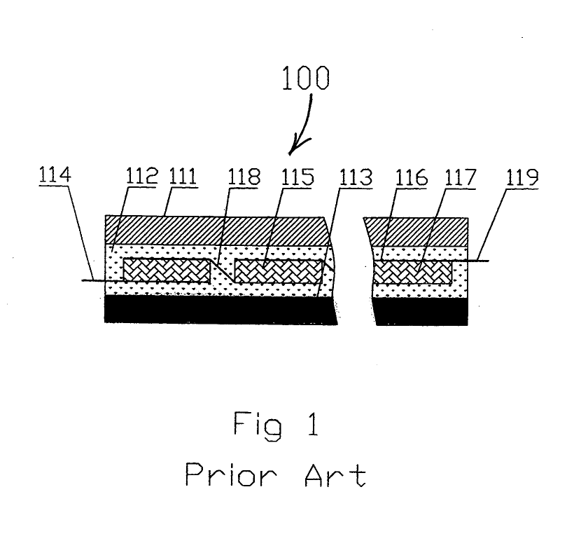

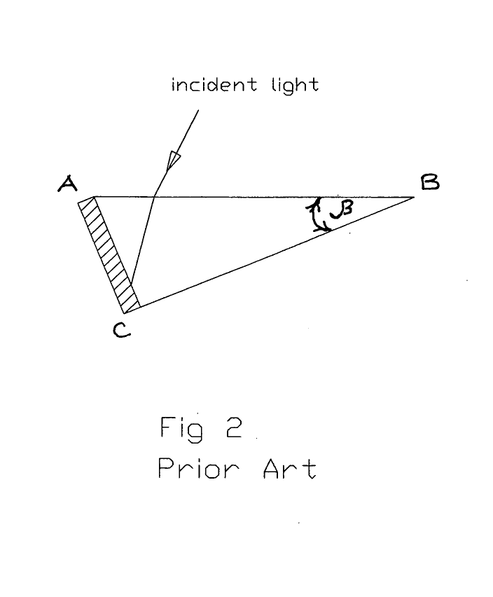

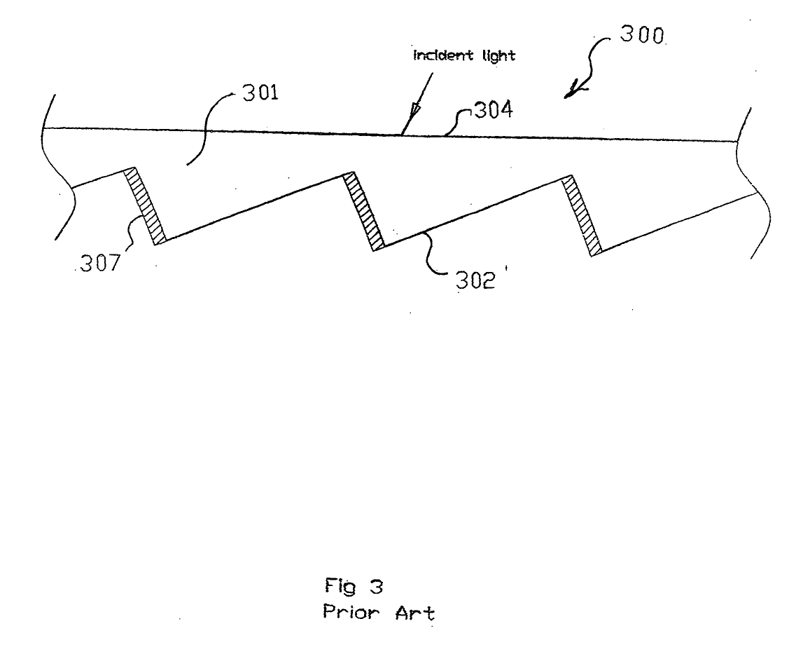

### DETAILED DESCRIPTION

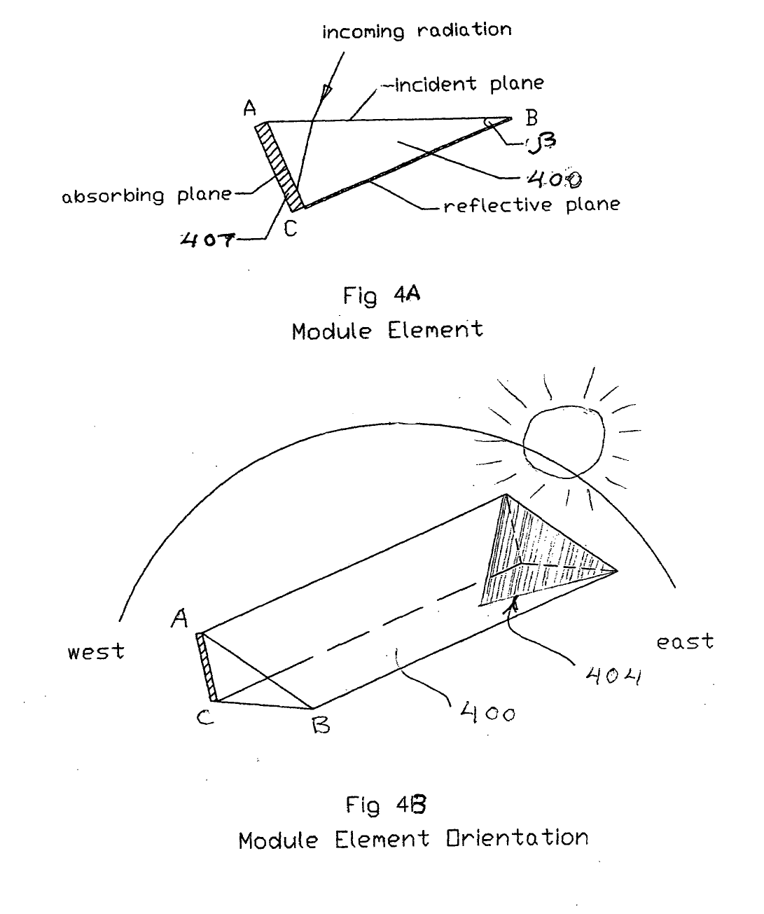

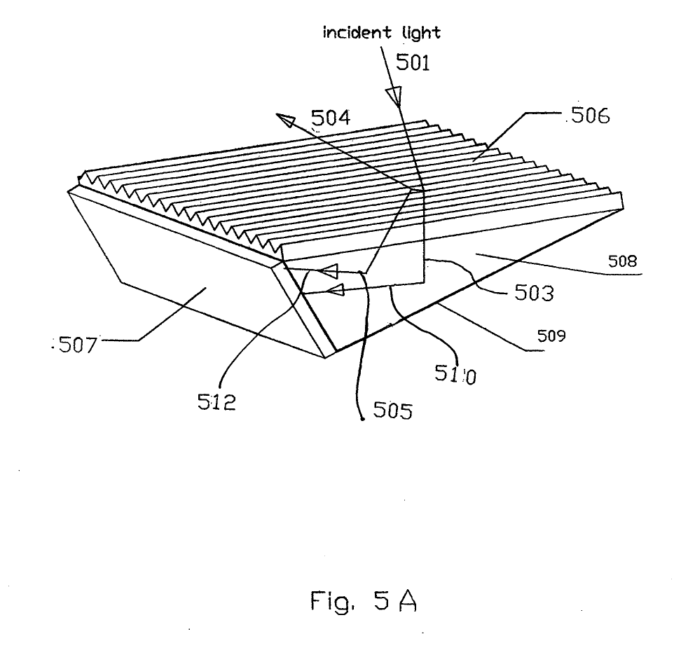

Referring to FIG. 4A, the illustrated prism 400 provides a definitional overview of the nomenclature used to describe the details of a modular element comprising a prism and integrated solar cell as set forth herein. Incoming radiation enters the prism 400 from the incident plane AB. The solar radiation is reflected on the reflective plane BC. The third plane of the prism, the absorbing plane AC, captures the radiation. A photo detector or array of solar cells 407 provided on plane AC converts the solar radiation into electrical energy. The apex angle of the prism is angle β. A photo detector attached to or provided on a single prism with the enhancements discussed below is called a PV “module element.” It is understood that a plurality of PV module elements are electrically coupled to form a PV module.

FIG. 4B shows that the shadow effect 404 is proportional to the depth or aspect ratio of the prism 400. Thus, it is important to orient the prism 400 so as to minimize shadow effect 404 caused by the changing orientation of the sun.

### Use of V-Grooved Face Plate Glass on the Prism

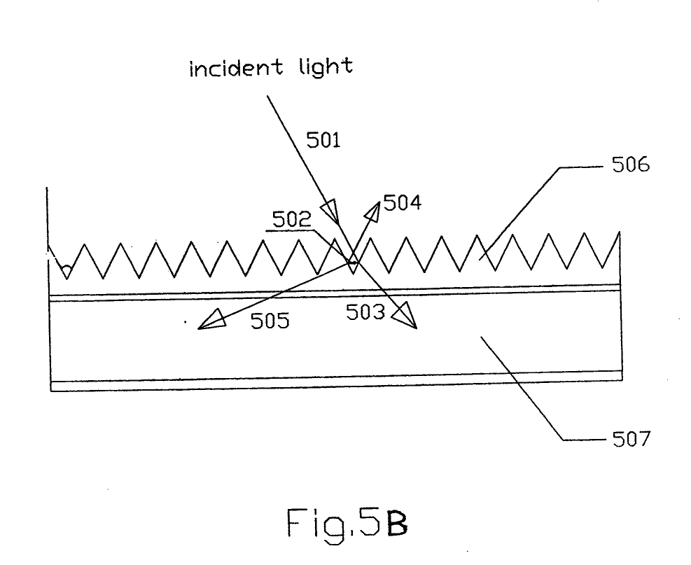

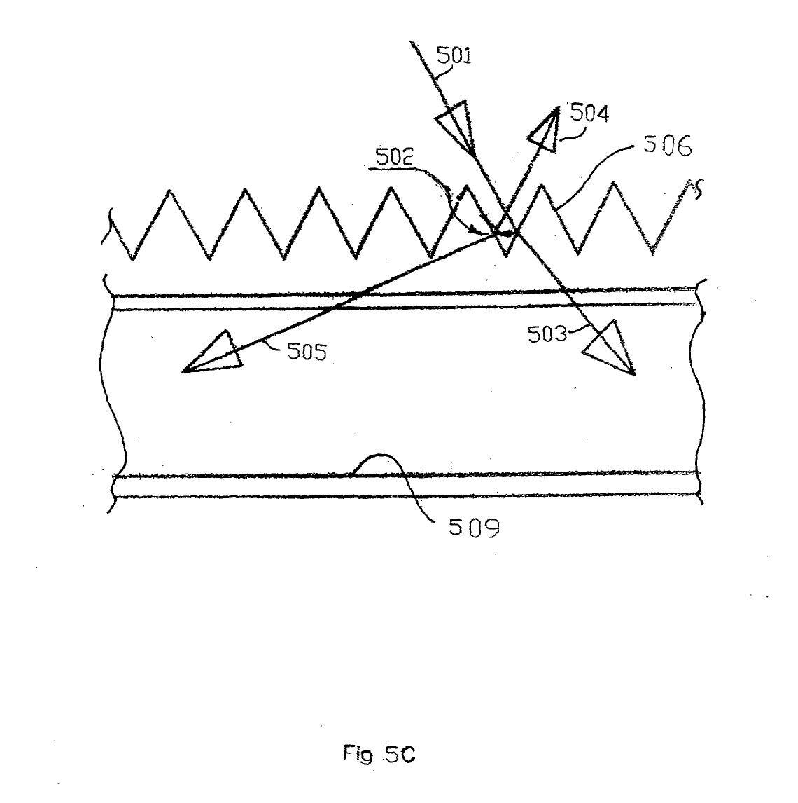

Referring to FIG. 5A, in accordance with an aspect of the invention, a V-grooved surface 500 comprising a series of V-grooves 506 is provided on the incident light plane of the prism 508. Providing a V-grooved surface on the incident light plane leads to a reduction of the reflective losses in incident optical radiation from 4% to below 0.2%. FIG. 5A shows a section of an individual module element with a V-grooved face plate. Typical V-groove patterns have the following metrics (see also FIG. 5B):
Distance between grooves: 0.2 mm
Typical angle of groove: 50 degrees
   The V-grooved face plate is attached to the prism using conventional PV industry bonding techniques, for example, using ethylene vinyl acetate (EVA) foil. However, other well known methods are also possible to achieve the same result. A full integration of the V-grooved surface into the body of the prism can be accomplished by any convenient method for providing a series of V-grooves on a macroscopic scale, such as by conventional cutting, scribing or etching, as is well known by those skilled in the art.

The V-grooves are oriented in the vertical direction in parallel with respect to the longitudinal axis of the prism 508 (as shown in FIG. 5A). Horizontal orientation leads to a similar reduction of reflection, however the vertical orientation improves the self-cleaning properties of the V-grooved light incident surface. In other words, rain will wash down dirt accumulating in the grooves, thereby reducing blockage of solar radiation caused by a build-up of dust, dirt and other environmental debris.

In order to further improve the properties of a V-grooved incident light plane, additional anti-reflective coatings can be applied to the surface of the V-grooves. These surface treatments use standard processes from the glass industry. Examples include sol-gel and dielectric coatings.

FIGS. 5A, 5B and 5C provide detailed diagrams of the prism in operation. Incident light or light rays following light path 501 refract at the side of a groove 506 on the light incident surface of prism 508. Since the light path 501 is incoming at a non reflecting angle, most of the energy will travel into the prism as refracted light along path 503. Only a small portion (typically 4% for a glass—air interface) will be reflected from the surface.

The reflection loss between two media is determined by the following formula:

Reflective Loss=(n−1)²/(n+1)²

where n is the refractive index of glass, which is typically 1.5.

Because of the V-groove cross-section of the incident light surface, the incoming light ray 501 refracts at the V-groove surface and the main portion (approximately 96%) is transmitted into the prism along light path 503. A small portion of that incoming light is reflected (approximately 4%) back into the opposite side of the V groove at point 502, where a small portion (approximately. 4% of the 4% of reflected light is equal to 0.16% of the original incoming light ray 501) of that light is reflected into the air along path 504, while the main portion (appr. 96% of 4% of the original light ray 501) of light at 502 is refracted into the prism along trajectory or path 505. Due to total internal reflection in prism 508, light following paths 503 and 505 is reflected from light reflecting surface 509 into successive trajectories or paths 510 and 512 respectively, and directed to photo detector 507 where the light is absorbed. Therefore, the total transmission of light energy into the prism is significantly improved to a level of approximately 99.8 per cent.

Although the reduction of surface reflection loss from 4% to below 0.2 might seem small, over the entire annual usage and lifetime (25 years and more) of a PV module, this improvement constitutes a major commercial benefit over a typical low concentrator PV system.

### Use of Blazed Grating on the Incident Light Plane

An alternative approach is the use of a blazed transmission grating on the incident light surface. Blazed grating surfaces allow a much more controllable way to direct light. The purpose of the blazed grating on the incident light plane is to capture and direct light into the prism that would otherwise be lost due to the critical angle constraints of the prism. Thus a blazed grating on the incident light surface overcomes the typical disadvantages of conventional low-concentrator solar modules in diffuse light.

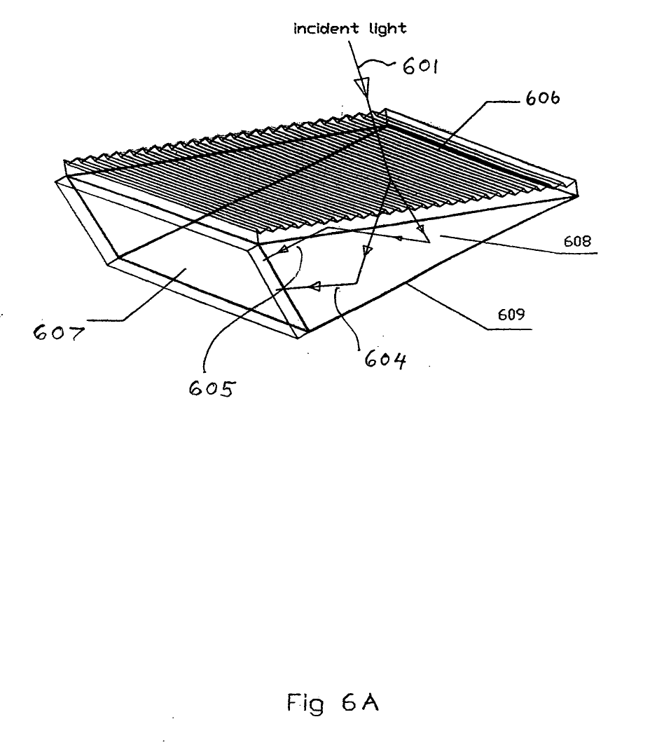

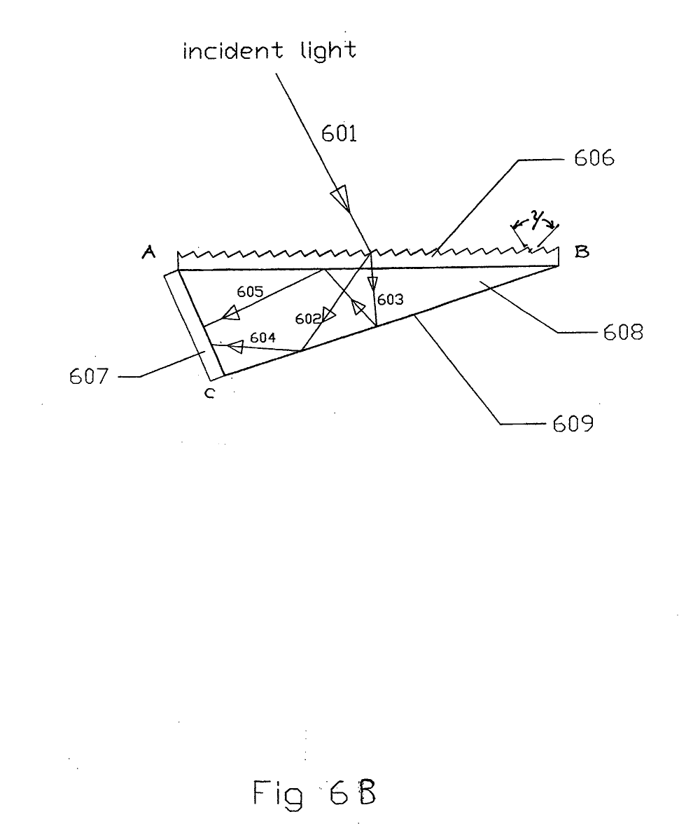

FIGS. 6A and 6B show a module element in accordance with an aspect of the invention provided with blazed transmission grating 606. The transmission grating 606 is provided on the incident surface AB of the prism 608 as a separate component. Alternatively, transmission grating 606 is formed by mechanically ruling the light incident surface AB of the prism 608, or by etching the surface AB of the prism 608 in a well known manner.

The blazed transmission grating 606 has a critical blazed angle γ that can be 5° to 50°; and is preferably in a range of 14° and a pitch of 600 grooves per mm to be most effective for a wavelength of 800 nm. The wavelength of 800 nm has been chosen because this is the portion of the spectrum that achieves maximum response from a conventional mono-crystalline silicon photo detector. That is, incoming radiation (sunlight) with this wavelength will result in maximum electrical energy conversion. Note: 13.88° is the exact number calculated for the selected wavelength of 800 nm; however this number can be rounded up to 14° without any practical degradation of the optical effect. Accordingly, the blazed grating provides a substantially nonreflecting surface with respect to a selected wavelength or bandwidth range of incident light, and provides a means for controllably directing incident light rays in the selected wavelength range into the prism; such that reflection losses are minimized.

The length of the wedge-shaped prism 608 is any convenient length, preferably 2 m or less and the prism apex angle β is smaller than 30° and is preferably 27.6 degrees for a glass prism. Note, there is no optical limitation regarding the length of the prism 608.

In accordance with an aspect of the invention, blazed grating surfaces are optimized for the sunlight wavelength band In this aspect of the invention, the blazed grating will capture and direct the wavelength spectrum that optimally can be converted into electrical energy by the PV cell array attached to the absorbing plane AC. An advantage of this wavelength specific energy transmission grating on the light incident surface is the reduction of radiation that has wavelengths that will transmit excess heat into the prism, but cannot be utilized by the photo receptor. For example, if crystalline silicon is being used the transmission grating will be chosen with the ability to filter out long wavelengths of light that cannot be used by the crystalline silicon photo receptor. This will lead to a reduction of temperature and consequently increase the energy yield of the PV system. For crystalline silicon photo detectors the efficiency for energy conversion drops at around 0.5% per 1 degree centigrade increase for temperatures above 25 degrees centigrade.

FIG. 6B shows in detail the path of incoming solar radiation when transmitted through a blazed grating light incident surface that is optimized for selection and transmission of specific wavelengths or bandwidths of radiation for maximizing photovoltaic conversion efficiency. Non optimal, heat producing wavelengths are rejected.

In operation, the incident light following path 601 is diffracted at the transmission blazed grating 606 and forms a plurality of light rays following trajectories or paths 602 and 603 (for example). The two sample light beams or rays following trajectories paths 602 and 603 are reflected by reflective surface 609 and the interior surface of AB as is characteristic of total internal reflection (TIR). Such a reflective surface 609 can be produced by aluminum sputtering, an industry standard process in the glass industry for mirrors. The two sample light rays are reflected back in total internal reflection along paths 604 and 605 to the absorbing plane AC and the attached solar cell or photoreceptor 607 where the light energy is converted into electrical power.

In summary, (for a non limiting example), a light incident surface AB comprising a blazed transmission grating 606 having a pitch of 600 groves per mm and blazed angle of 13.88, or about 14 degrees can selectively capture substantially all incoming sunlight in the 800 nm bandwidth (with substantially no reflection loss) and direct that light into the prism by refraction. Due to the TIR condition in the prism and the reflective surface BC, substantially all of the useful bandwidth of incoming sunlight is captured and directed to the light absorbing surface AC. Also, due to the wavelength selective transmission grating, longer, heat producing wavelengths outside the 800 nm band are rejected, thereby keeping light absorbing surface AC cooler and increasing conversion efficiency.

### Improving the Reflective Properties of the Prism

Prism based concentrators have practical limitations regarding the magnification of incoming radiation. With conventional material, e.g. glass, acrylic, polycarbonate, total internal reflection (TIR) can only be achieved with apex angles of 20-30 degrees, resulting in a magnification of the incoming radiation by a factor of 1.5 to approximately 2.5. For a glass prism with an apex angle of 27.6 degrees, magnification is equal to 2.1. It is important that a PV module must be warranted for a lifetime of about 25 years. Due to the need to guarantee operability over such a long period, the PV module industry so far has not accepted any non-glass components. This implies that only glass prisms will be a viable solution in the near term.

As explained below, an aspect of the present invention can achieve significantly higher silicon savings, up to 50% or more, and still stay within the accepted parameters of the solar industry, using only proven long lifetime components.

### Use of Blazed Grating on the Reflective Plane

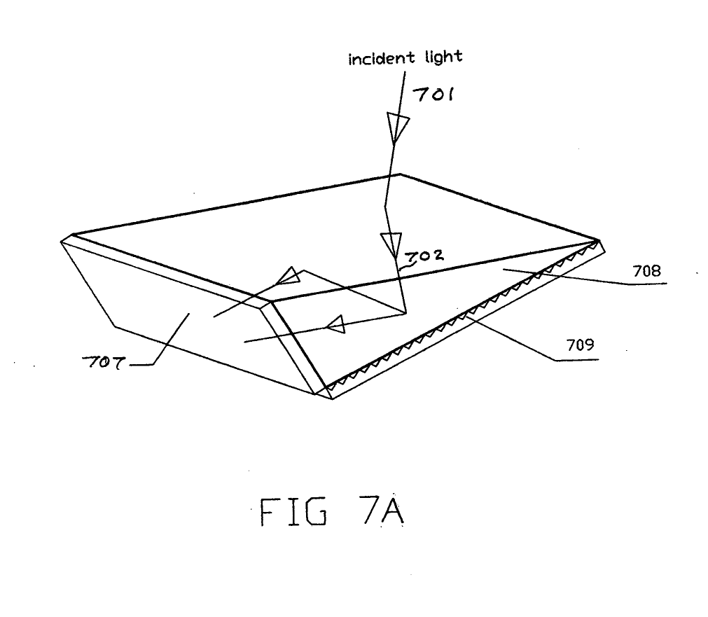

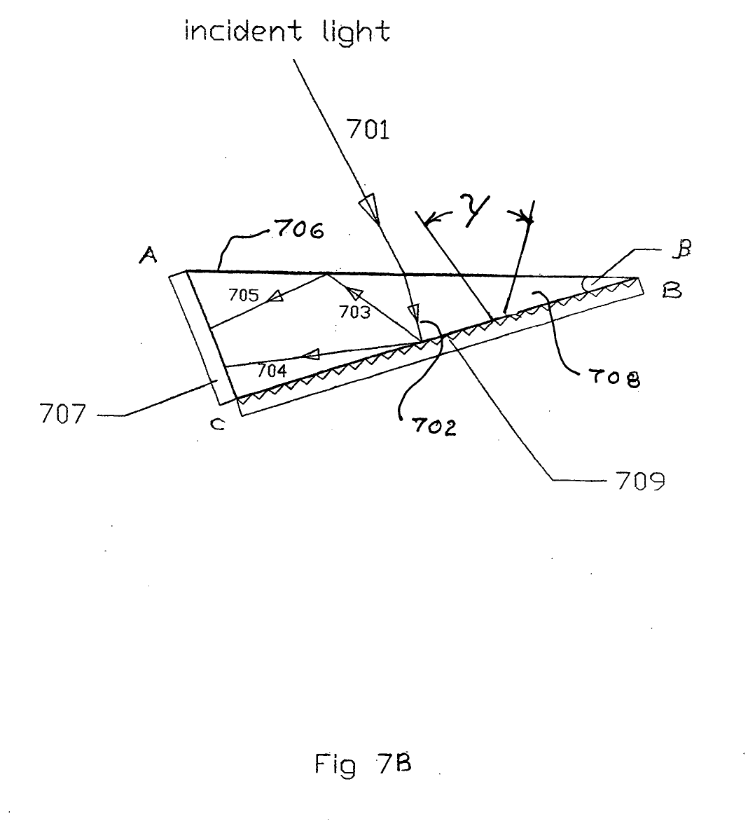

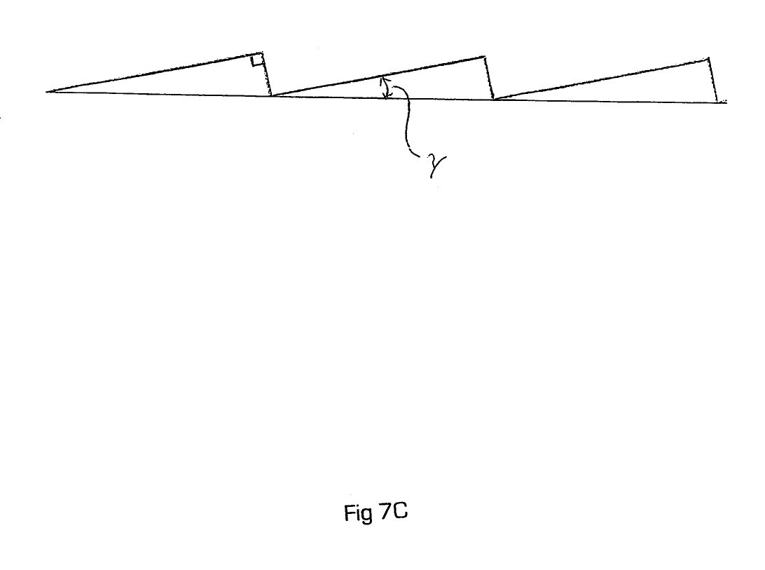

FIGS. 7A, 7B and 7C show a PV module 700 comprising low concentrator prism 708 and solar array 707. A blazed reflection grating 709 is provided on the reflection surface BC of prism 708. The blazed reflection grating 709 may be attached to the reflection surface BC of the prism 708 as a separate component, or it may formed by etching the surface BC of prism 708 in any convenient and well known manner as is well understood by one skilled in the art.

The reflection blazed grating angle γ (refer to FIG. 7C) can be 5° to 50° depending on the desired groove density and wavelength to be selected. The length of the wedge-shaped prism 708 is any convenient length less than 2 m; and the prism apex angle β is preferably smaller than 30° and can be as low as 2-10 degrees and still achieve a TIR condition. The backside of the reflection blazed reflection grating 709 is covered with a reflective coating, such as aluminum foil.

In operation, incident light following path 701 refracts at the transparent light incident surface AB into light path 702. The reflection grating 709 reflects incoming light from path 702 onto other paths depending on the angle of the sun, for example, paths 704 and 703. The diffraction angle of the reflection blazed grating 709 is wavelength dependent. The diffraction angle is larger for longer wavelength light following light path 704 from the reflection blazed grating 709 compared to that of shorter wavelength light following path 703. The diffracted light following path 703 travels back to the interior surface of light incident surface AB with a larger incident angle, and experiences total internal reflection at the surface AB where it is reflected into path 705. The reflected light following paths 705 and 704 passes through the smaller light absorbing surface AC where it is converted to electrical power by the PV array 707.

The magnification ratio of concentrator PV module 700 is defined by equation

M=1/sin β

It will be appreciated that this aspect of invention, using a blazed grating reflective surface on the BC plane, enables the total internal reflection condition to be achieved with a significantly smaller apex angleβ, that results in a higher magnification ratio M. This provides a low aspect ratio collector PV module that has many advantages over a conventional prism based PV module.

Based on the known properties of blazed grating surfaces, the reduction of the apex angle β is very significant. For example, apex angles of prism 708 can be achieved that are smaller than 10° depending on the groove density and wavelength. For a blazed grating groove density of 600 grooves per mm and blazed grating angle of 14°, the apex angle for prism 708 can be in the range of 10° and still achieve equivalent energy absorption like a conventional prism with an angle of 30°. A preferred apex angle for such a prism 708 is appr. 10° degrees. The comparable apex angle β of a conventional prism is, as discussed above, is about 30 degrees or more.

It will be appreciated that the foregoing small apex angle results in a low aspect ratio prism with a light absorbing surface AC that advantageously has a reduced surface area without loss of photovoltaic conversion efficiency due to increased magnification and the ability of the blazed grating on the light incident and/or light reflective surfaces to capture more incoming solar radiation. The foregoing reduced surface area leads to a reduction in the amount of silicon needed for the photo detector surface AC. This has the effect of drastically reducing the manufacturing cost of a prism PV module.

When compared to a conventional flat plate PV module, the low aspect ratio feature of the present invention leads to savings in silicon consumption by a factor of 5 or 6. A PV module constructed in accordance with this aspect of the invention uses ½ to ⅔ less silicon than a conventional prism based PV module.

An additional advantage achieved by the low aspect ratio of the invention is that the smaller, low aspect ratio prism leads to a much lighter PV module 708. This would enable widespread implementation of a high efficiency prism based collector PV module on rooftops or other applications where light weight and high photo conversion efficiency are important.

Another advantage of the foregoing aspect of the invention is that the light shadow effect (shown at 404 in FIG. 4B) on photovoltaic output is lessened because of the smaller prism apex angle β. The shadow effect is proportional to the depth or aspect ratio of the prism. If a shallow apex angle reduces the depth of the prism by, for example, 50 per cent, the shadow effect is reduced by 50 per cent. Thus, a further increase in photovoltaic conversion efficiency can be achieved in comparison to a conventional PV module of the same overall size.

### Use of V-Grooved Face Plate Glass and Blazed Grating on the Reflective Plane

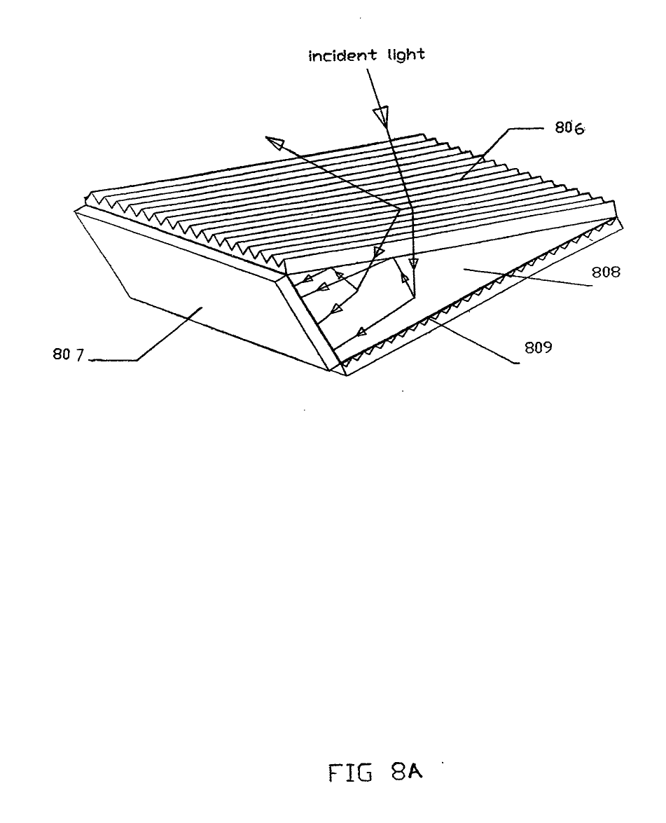

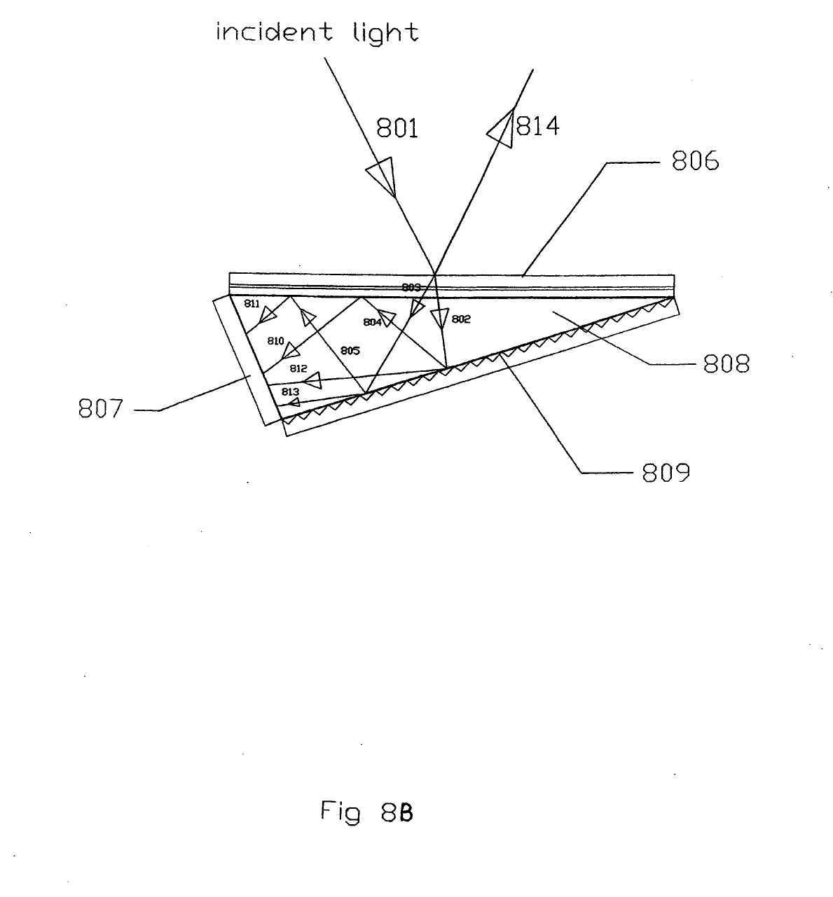

It will be appreciated that an aspect of the invention comprises a combination of the foregoing V-grooved face plate glass on the light incident plane of the prism with a blazed grating provided on the reflective plane in a single PV module element. An example of this combination is shown in FIGS. 8A and 8B. The operation and advantages of such a combination of the V-grooved face plate glass on the light incident plane and a blazed grating provided on the reflective plane of a prism PV module are generally the same as set forth in the foregoing description of FIGS. 5A, 5B, 6A, 6B, 7A and 7B.

Referring to FIGS. 8A and 8B, incident light rays following path 801 will enter the prism following the paths 803 and 802 (note: 803 is analogous to 503 and 802 is analogous to 505 as described above in FIG. 5). Only a small portion of the light will be reflected from the incident light plane following path 814 (note: 814 is analogous to 504).

Light rays following paths 802 and 803 will be reflected on the reflective plane 809. In the example given, each light ray reaching the reflective plane will be reflected by the blazed grating. (Note: the reflective properties shown in FIG. 8A and 8B are analogous to the ones shown in FIG. 7). Two sample rays per incoming ray are shown in FIG. 8. Light ray 802 will be reflected into 804 and 812, light ray 803 will be reflected into 805 and 813 being then received by the photo detector directly or through one additional reflection. (Note: 802 and 803 are analogous to 702, 804/805 are analogous to 703, 812/813 are analogous to 704) Here as in FIG. 7C, an optimal groove density or pitch for the blazed reflection grating 809 is 600 groves per mm having a blazed angle γ of 14°. These parameters are the optimum for a wavelength of 800 nm, the important wave band for mono crystalline photo detectors.

### Use of Blazed Transmission Grating on the Incident Light Plane and Blazed Grating on the Reflective Plane

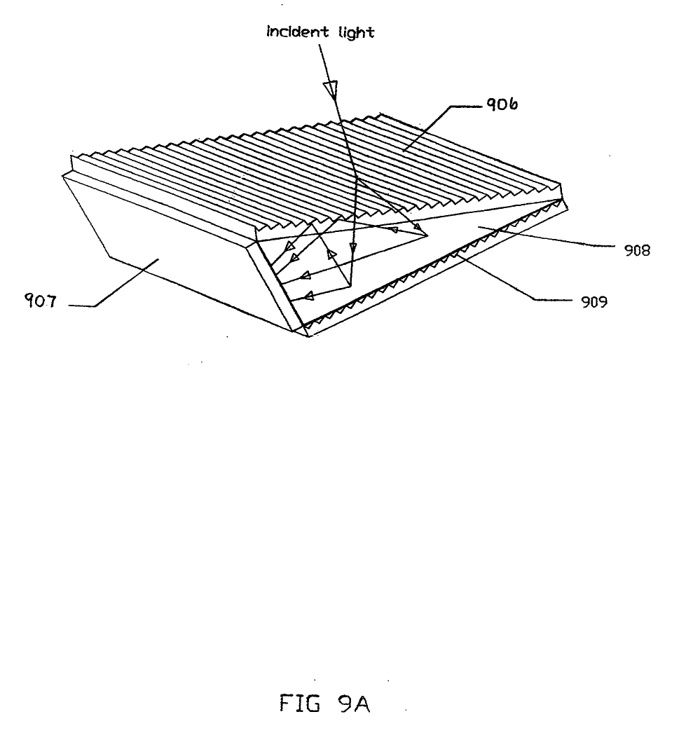

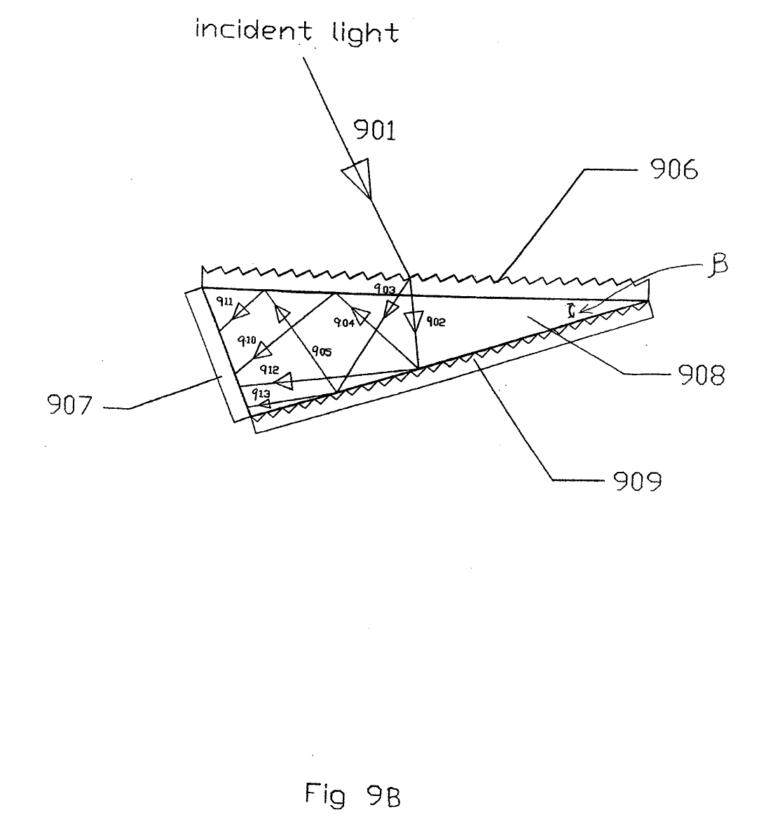

FIGS. 9A and 9B show the combination of a blazed transmission grating provided on the incident light plane glass and blazed reflection grating provided on the reflective plane in a single PV module element.

Referring to FIGS. 9A and 9B, incident light rays following trajectory or path 901 will enter the prism following the trajectories or paths 903 and 902 (note: 903 is analogous to 602 and 902 is analogous to 603 as described above in FIGS. 6A, 6B).

Light rays following paths 902 and 903 will be reflected on the reflective plane 909. In the example given, each light ray reaching the reflective plane will be reflected by the blazed grating. (Note: the reflective properties shown in FIG. 8A and 8B are analogous to the ones shown in FIG. 7A, 7B and 7C). Referring to FIGS. 9A and 9B, each incoming light ray along path 901 refracts into two example trajectories or paths 902 and 903 per incoming ray. Light ray 902 will be reflected into 904 and 912, light ray 903 will be reflected into 905 and 913 being then received by the photo detector 907 directly or through an additional reflection. (Note: 902/903 are analogous to 702; 904/905 are analogous to 703; 912/913 are analogous to 704.)

It will be appreciated that the selection of the blazed grating parameters (such as groove angle and distance between grooves, or groove density) on the incident light plane 906 and the parameters of the blazed grating of the reflective light plane 909 can be optimized such that optimal wavelengths of light energy will be absorbed by the photo receptor 907. The optimization criteria are:
maximize light energy that can be absorbed by the respective photo receptor;
maximize view angle
minimize apex angle β
minimize the heat exposure of the photo receptor

An example of a PV module element with such optimized wavelength selective parameters that would maximize photo voltaic output would be a blazed transmission grating with the following properties: blazed angle of 14° and a groove density or pitch of 600 grooves per mm. The apex angle β can be reduced to 10° without any loss in effectiveness in light capturing on the target wavelength band of 800 nm. The additional advantage of the blazed grating surface treatment is that the view angle will be increased to approximately 160°. For a traditional prism with an apex angle of 30 degrees the view angle is limited to approximately 100°. The main disadvantage of a limited view angle is that the photo receptor has a proportionally reduced diffuse light capturing capability

Such a module would minimize heat exposure to the photoreceptor surface. Wavelength selective parameters of the transmission grating surface 906 provided on the light incident surface of prism 908 and the photo reflective parameters of reflection grating 909 on the reflecting plane of prism 908 can be separately optimized to increase photovoltaic conversion efficiency from the photo receptor 907. A wide range of practical combinations for a specific implementation is possible.

### Implementation of Module Elements in a Practical, Low Aspect Ratio Concentrator PV Module

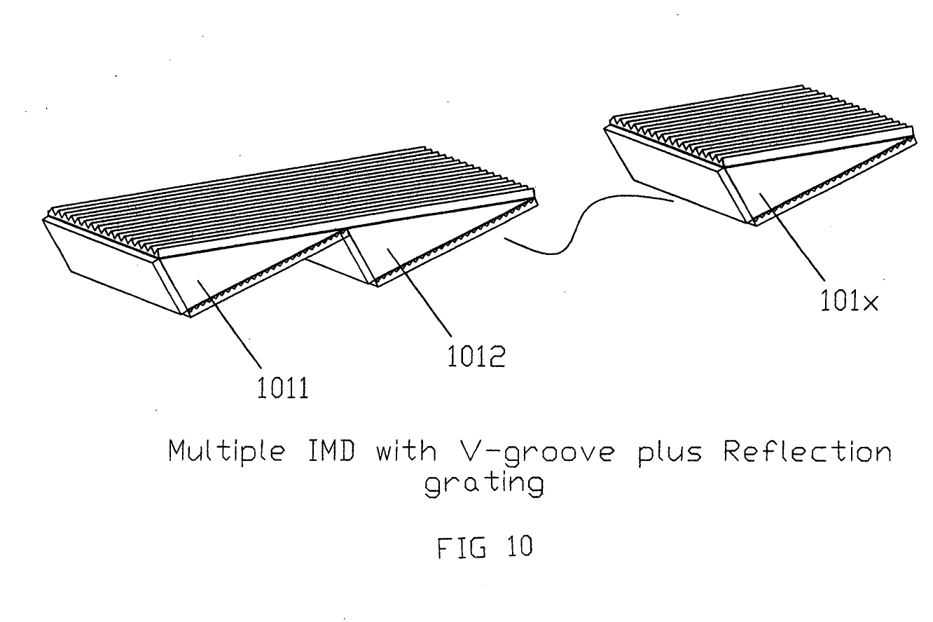

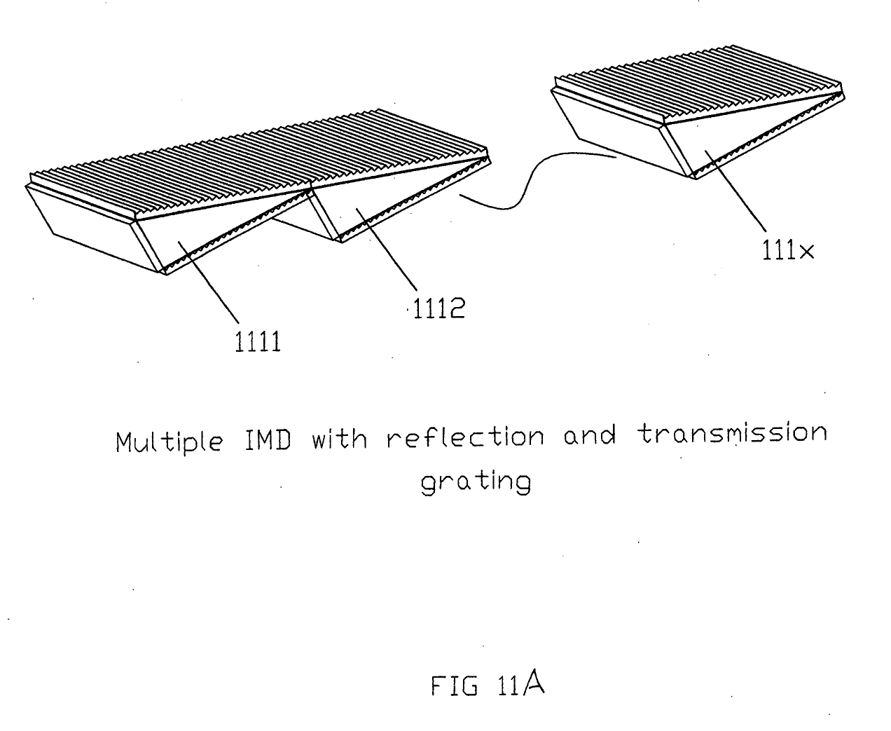

FIGS. 10 through 15 illustrate how foregoing aspects of the invention can be implemented in a practical and easily manufactured low aspect ratio PV module. The implementation is based on existing PV manufacturing methods. However, the introduction of a blazed grating requires special care to protect the micro-scale blazed grating surface structure from any damage. In contrast, a V-grooved faceplate is a macroscopic structure that can be exposed to the elements without any damage.

FIG. 10 shows an arrangement of multiple individual module elements (1011, 1012, . . . 101x) accordance with the foregoing description attached to a V-grooved face plate. The module elements are attached by PV industry standard methods, for example using EVA.

### Multiple Individual Module Elements with Blazed Grating On Incident and Reflective Planes

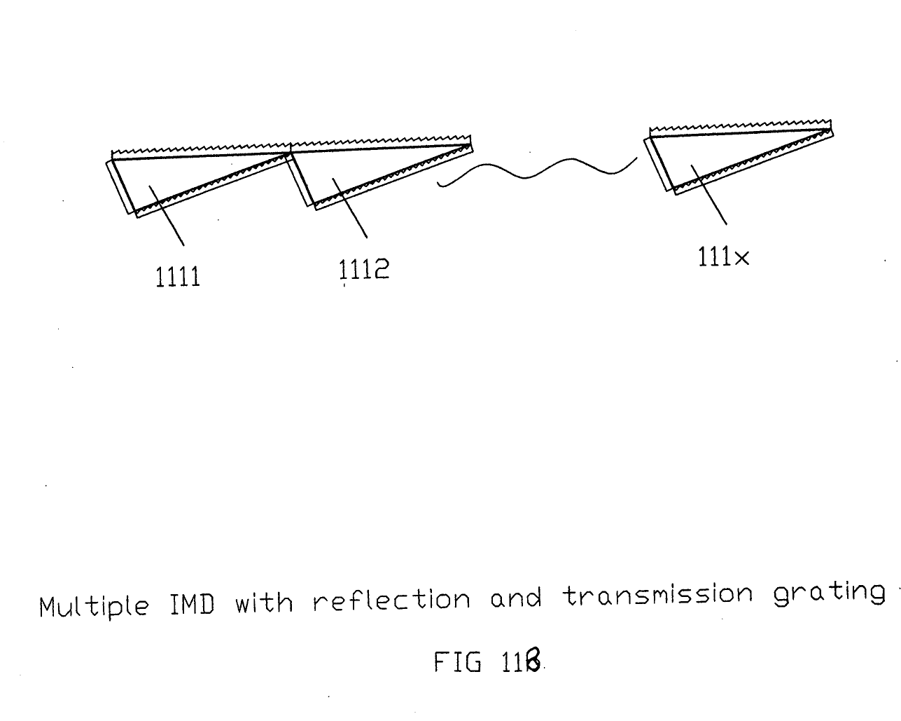

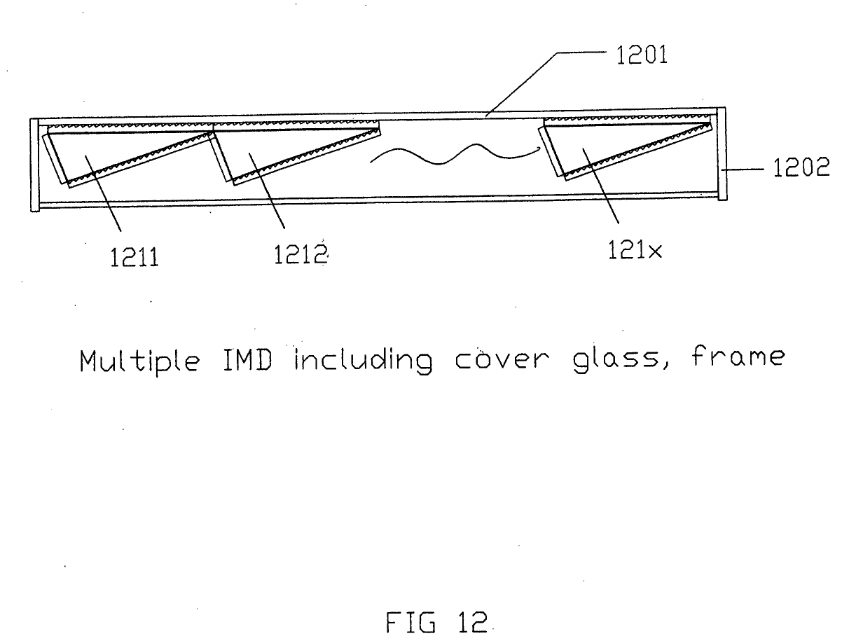

FIGS. 11A and 11B show a perspective view and cross section respectively, of multiple module elements (1111, 1112, . . . 111x) connected to form a PV module. The elements 1111 . . . 111x are provided with a transmission blazed grating on the light incident plane and reflective blazed grating on the reflective plane to produce the advantages previously described.

Due to the fact that blazed gratings are very fragile structures, their protection from the elements and other mechanical stress is paramount for a reliable PV module.

FIG. 12 shows a PV module comprising an array of module elements provided with a blazed transmission grating on the light incident surface. The fragile blazed grating is protected by a glass faceplate 1201. The faceplate is attached to the incident light plane using any standard method in the PV module industry that is well known to those skilled in the art.

### Multiple Monolithic Module Elements with V-Grooves and Reflection Grating

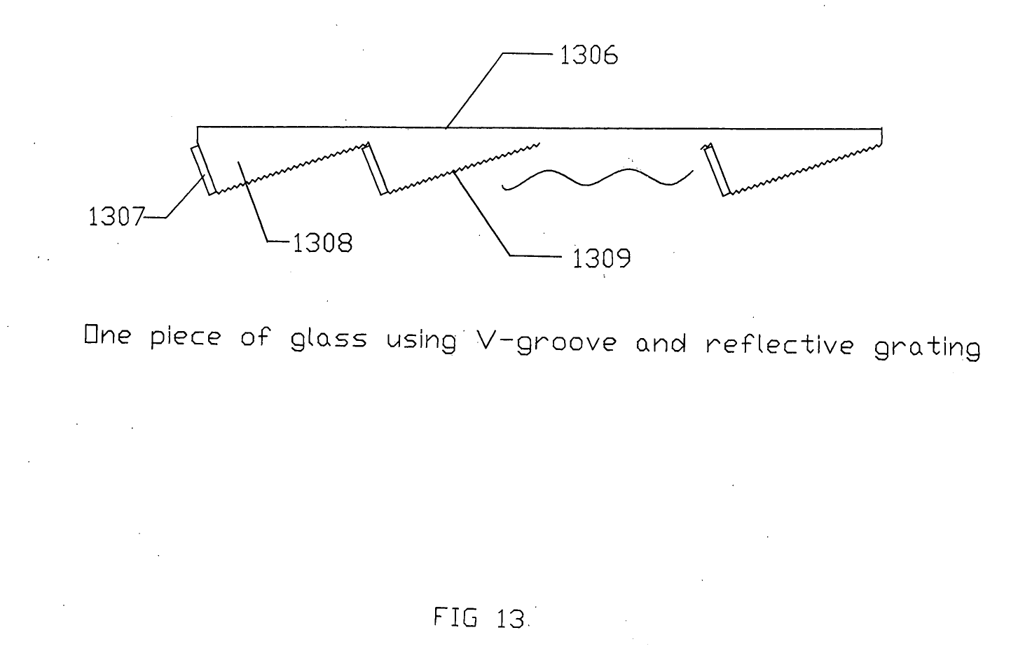

Referring to FIG. 13, in order to further reduce the manufacturing cost of integrating module elements into a PV module, individual module elements can be produced using a one piece, monolithic glass body in accordance with standard techniques that are well known to one skilled in the art, such as standard glass manufacturing processes.

In this way the assembly cost of individual module elements is advantageously eliminated. FIG. 13 shows such a monolithic PV module. Note that the V-grooved faceplate does not require any additional face plate protection.

### Multiple Monolithic Module Elements With Blazed Gratings on Incident and Reflective Planes and Protective Glass Face Plate

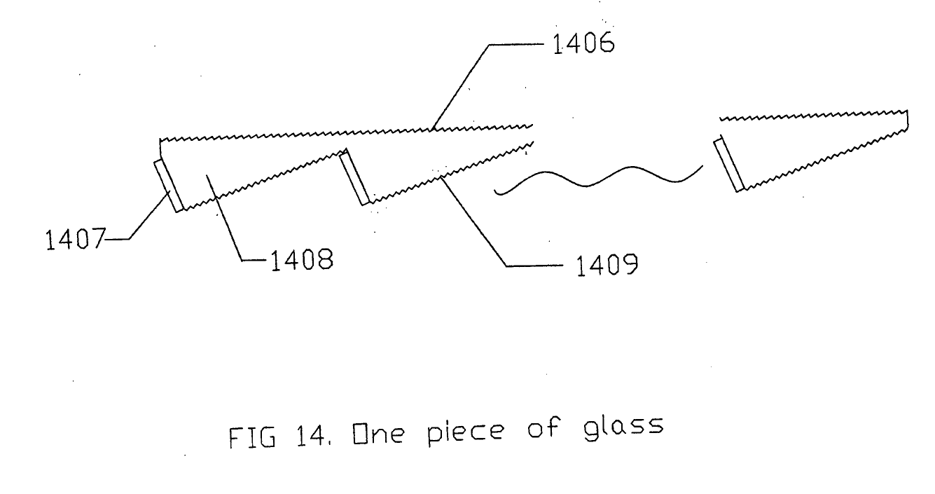

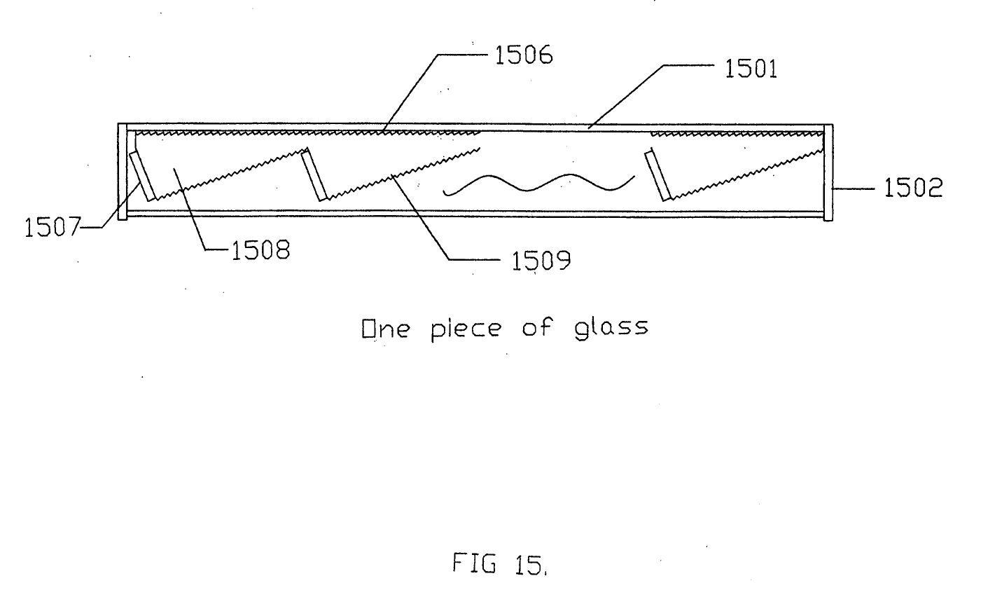

FIG. 14 shows a monolithic arrangement of a PV module comprising an array of module elements with blazed transmission and reflection gratings as described herein provided on the incident and reflective planes, respectively. The array of module elements can be manufactured from a single piece of glass as illustrated, according to techniques that are well known to those skilled in the art. This embodiment leads to a significant savings in manufacturing cost, because it eliminates the assembly of the individual module elements. In order to protect the transmission blazed grating from the elements, the attachment of a face plate may be required as shown in FIG. 15.

While the invention has been described in connection with what are presently considered to be the most practical and preferred embodiments, it is to be understood that the invention is not limited to the disclosed embodiments and alternatives as set forth above, but on the contrary is intended to cover various modifications and equivalent arrangements included within the scope of the following claims.

For example, combinations of the foregoing PV concentrators or module elements can be implemented in a PV module based on existing PV manufacturing methods. Multiple individual module elements can be electrically connected and attached to a single V-grooved, light incident face plate. Also, a plurality of modules or combinations of modules can be connected and/or formed from a single piece of glass or other prism material.

Other equivalent configurations for transmission and reflection gratings may be used to select and reflect optimal ranges of wavelengths of radiation to the light absorbing plane. What is important is that such transmission and reflection gratings achieve total internal reflection with an extremely small apex angle β, on the order of 10 degrees or less, that results in a higher magnification ratio. This provides a light weight, low aspect ratio collector PV module that results in significant savings in silicon without loss of photovoltaic conversion efficiency as previously explained.

Therefore, persons of ordinary skill in this field are to understand that all such equivalent arrangements and modifications are to be included within the scope of the following claims

We claim:

1. A prism solar module characterized by total internal reflection (TIR) comprising:
a light incident surface comprising a series of V shaped grooves, each groove having opposed first and second sides joined at an angle for minimizing reflection with respect to incident light for directing an incident light ray by refraction along a first trajectory into the prism; and each side of the V groove positioned for receiving a reflected portion of the incident light ray and for directing that reflected portion back through an opposing side along a second trajectory into the prism;
a light absorbing surface comprising a photovoltaic module for converting received light rays into electrical energy; and
a reflection surface joined to light absorbing surface and to the light incident surface at an angle such that incident light directed into the prism on the first and second trajectories is maintained by TIR within the prism and directed to the light absorbing surface.

2. A prism as in claim 1, wherein the sides of the V grooves are joined at an angle in a range of from 40-60 degrees and most preferably at an angle of about 50 degrees.

3. A prism as in claim 1, wherein the V grooves are spaced apart at a distance in a range of from 0.1 mm to 0.4 mm and most preferably at a distance of about 0.2 mm.

4. A prism as in claim 1 wherein the V-grooves comprise a grooved face plate provided on the light incident surface using conventional PV industry bonding techniques, such as by ethylene vinyl acetate (EVA) foil or the like.

5. A prism as in claim 1 wherein the V-grooves are provided integrally in the light incident surface of the prism.

6. A solar module comprising
a prism characterized by total internal reflection and having a light incident surface comprising a series of V shaped grooves extending substantially in parallel along a longitudinal axis of the prism, the V-grooves having opposed first and second sides joined at a substantially nonreflecting angle with respect to incident light for directing an incident light beam along a first trajectory into the prism; and each side of the V groove positioned at an angle for receiving a reflected portion of the incident light beam for directing that reflected portion back into the prism along a second trajectory;
a light absorbing surface including a one or more solar cells responsive to received light for converting that light into electrical energy;
a reflection surface joined to the light absorbing surface at an apex angle that maintains TIR such that incident light beams directed into the prism are reflected to the light absorbing surface.

7. A prism solar module characterized by total internal reflection (TIR) and reduced apex angle comprising:
a blazed grating light incident surface characterized by a multitude of grooves disposed for providing a substantially nonreflecting surface for capturing selected wavelengths of incident light rays substantially without reflection losses, and for directing the incident light rays into the prism;
a light absorbing surface comprising a photovoltaic module for converting received light into electrical energy; and
a reflection surface joined to the light incident surface at a minimized apex angle such that all incident light directed into the prism is maintained therein by TIR and directed to the light absorbing surface.

8. A low aspect ratio solar module as in claim 7 wherein the blazed grating is characterized by a blazed angle γ in a range of from 5° to 50°; and most preferably in a range of from 13.5-14° and a pitch of 600 grooves per mm for capturing incident light having a wavelength of 800 nm.

9. A solar module as in claim 8 wherein the apex angle β of the prism is smaller than 30°.

10. A solar module as in claim 8 wherein the prism is comprised of glass and is characterized by an apex angle in a range from 25-30 degrees and preferably about 27.6 degrees.

11. A solar module characterized by total internal reflection (TIR) and reduced apex angle comprising:
a light incident surface comprising a wavelength specific blazed grating for transmitting incident light radiation of a selected bandwidth into the prism,
a light absorbing surface comprising one or more a solar cells responsive to the transmitted radiation for converting it into electrical energy;
a reflective surface, forming a reduced apex angle with the light incident surface that maintains TIR within the prism, such that transmitted light radiation within the prism is directed to the light absorbing surface.

12. A solar module as in claim 11, wherein the prism is comprised of glass and is characterized by an apex angle in a range from 25-30 degrees and preferably about 27.6 degrees.

13. A solar module as in claim 11, wherein the blazed grating is characterized by a blazed angle γ in a range of from 5° to 50°; and most preferably in a range of from 13.5-14° and a pitch of 600 grooves per mm for selectively capturing incident light having a wavelength of 800 nm.

14. A low aspect ratio prism solar module characterized by total internal reflection (TIR) comprising:
a light incident surface transparent to incident solar radiation for transmitting incident solar radiation into the prism;
a light absorbing surface comprising one or more solar cells responsive to received radiation for converting the radiation into electrical energy;
a reflection surface comprising a blazed reflection grating forming a low aspect ratio apex angle at a shared point with the light incident surface, the blazed reflection grating having a blazed angle and groove density such that a condition of TIR is maintained within the prism for reflecting the transmitted radiation to the light absorbing surface.

15. A low aspect ratio prism solar module as in claim 14, wherein the TIR condition is maintained with an apex angle of 10 degrees or less.

16. A low aspect ratio prism solar module as in claim 14, wherein the blazed reflection grating is characterized by a groove density in a range of 400-700 grooves per mm and preferably about 600 grooves per mm and a blazed grating angle of about 14°.

17. A low aspect ratio prism solar module characterized by a reduced apex angle for maintaining total internal reflection (TIR) comprising:
a light incident surface comprising a series of V shaped grooves, each groove having opposed first and second sides joined at an angle for minimizing reflection with respect to incident light and for directing incident light by refraction along a first trajectory into the prism; and each side of the V groove positioned for receiving a reflected portion of the incident light and for directing that reflected portion back through an opposing side along a second trajectory into the prism;
a light absorbing surface opposite the apex angle comprising a photovoltaic module for converting received light rays into electrical energy; and
a reflection surface comprising a blazed reflection grating forming a small apex angle at a shared point with the light incident surface, the blazed reflection grating having a blazed angle and groove density such that light directed into the prism on the first and second trajectories is maintained by TIR within the prism and directed to the light absorbing surface.

18. A solar module as in claim 17, wherein the TIR condition is maintained with an apex angle of 10 degrees or less.

19. A solar module as in claim 17, wherein the blazed reflection grating is characterized by a groove density in a range of 400-700 grooves per mm and preferably about 600 grooves per mm and a blazed grating angle of about 14°.

20. A solar module as in claim 17, wherein the sides of the V grooves are joined at an angle in a range of from 40-60 degrees and most preferably at an angle of about 50 degrees.

21. A solar module as in claim 17, wherein the V grooves are spaced apart at a distance in a range of from 0.1 mm to 0.4 mm and most preferably at a distance of about 0.2 mm.

22. A solar module as in claim 17 wherein a plurality of solar modules, having a common V-groove, light incident surface, are formed from a single piece of glass.

23. A prism solar module characterized by a reduced apex angle and low aspect ratio for maintaining total internal reflection (TIR) comprising:
a light incident surface comprising a transmission blazed grating for capturing a selected bandwidth of incident light substantially without reflection losses, and for directing the incident light into the prism;
a light absorbing surface opposite the apex angle comprising a photovoltaic module for converting received light into electrical energy; and
a reflection surface comprising a blazed reflection grating forming a small apex angle at a shared point with the light incident surface, the blazed reflection grating having a blazed angle and groove density such that light directed into the prism is maintained by TIR within the prism and directed to the light absorbing surface.

24. A solar module as in claim 23, wherein the TIR condition is maintained with an apex angle of 10 degrees or less.

25. A solar module as in claim 23, wherein the blazed reflection grating is characterized by a groove density in a range of 400-700 grooves per mm and preferably about 600 grooves per mm and a blazed grating angle of about 14°.

26. A low aspect ratio solar module as in claim 23 wherein the blazed transmission grating is characterized by a blazed angle γ in a range of from 5° to 50°; and most preferably in a range of from 13.5-14° and a pitch of 600 grooves per mm for capturing incident light having a wavelength of 800 nm.

27. A low aspect ratio solar module as in claim 23 wherein a plurality of solar modules, having a common light incident transmission blazed grating surface, are formed from a single piece of glass.
